(19) United States
(12) Patent Application Publication
(10) Pub. No.: US 2024/0423130 A1
(43) Pub. Date: Dec. 26, 2024

(54) CROP DIVIDER OF A HARVESTING APPARATUS, HAVING A DIVIDER TIP

(71) Applicant: Carl Geringhoff GmbH & Co. KG, Ahlen (DE)

(72) Inventors: CLAUDIA THIEMANN, Beckum (DE); JOHANNES HENSE, Wadersloh (DE); RÜDIGER STEEN, Bunde (DE)

(21) Appl. No.: 18/747,120

(22) Filed: Jun. 18, 2024

(30) Foreign Application Priority Data
Jun. 20, 2023 (DE) 102023116099.0

(51) Int. Cl. A01D 63/04; A01D 45/02

(52) U.S. Cl. CPC A01D 63/04; A01D 45/021

(57) ABSTRACT

A harvesting apparatus having at least one crop divider which has a divider tip pointing in a working direction of the harvesting apparatus, which divider tip, on its side facing toward the ground, forms a support surface by which the divider tip slides on the surface of the ground when in contact with the ground. To improve ground tracking and ensure optimum crop pick-up, the crop divider has an exchangeable insert which, in a first installation position, protrudes with its shape beyond a surrounding part of the support surface by a first protrusion dimension in the direction of the ground and, in a second installation position, protrudes with its shape beyond a surrounding part of the support surface by a second protrusion dimension in the direction of the ground, wherein the second protrusion dimension is smaller than the first protrusion dimension and may also correspond to the value 0.

### CROSS REFERENCE TO RELATED APPLICATIONS

This application claims priority under 35 U.S.C. § 119 to German Patent Application DE 10 2023 116 099.0, filed Jun. 20, 2023, which is herein incorporated by reference in its entirety, including without limitation, the specification, claims, and abstract, as well as any figures, tables, appendices, or drawings thereof.

### FIELD OF THE INVENTION

The present invention relates to a harvesting device having a divider tip.

### BACKGROUND OF THE INVENTION

The background description provided herein gives context for the present disclosure. Work of the presently named inventors, as well as aspects of the description that may not otherwise qualify as prior art at the time of filing, are neither expressly nor impliedly admitted as prior art.

The document US 2003/0037528 A1 has disclosed a generic harvesting apparatus in the form of a corn header having a crop divider and having a divider tip, which is produced from a plastics material and which, when required, can be mounted onto the front of the crop divider. The divider tip has a fixed, invariant basic shape that is designed to match the basic shape of the crop divider that is covered by said divider tip. The vertical guidance and support of the divider tip that is mounted onto the crop divider remains unchanged in relation to the crop divider without the mounted divider tip.

For the function of the crop header, it is highly important that the corn stalks cleanly enter the narrow picking gap of a corresponding row unit. For the combine harvest-er driver, the zone in which the corn stalks enter the picking gap is difficult to see, and is concealed by the crops entering said picking gap. Furthermore, depositing inaccuracies may have occurred during the sowing of the corn kernels, such that the corn stalks have not grown exactly in a line with exactly the proper spacings to the corn kernels deposited in parallel rows. In order that each of the corn stalks that are to be harvested is directed into the picking gap despite these inaccuracies, tapered crop dividers are installed in a corn header, which crop dividers, by means of their shape, suitably direct the corn stalks, in a transverse direction with respect to the working direction, into the picking gap. By means of their basic shape, which conically tapers in the working direction and which is truncated at the ground-facing side, the crop dividers form, with the divider tips, a type of funnel in which the crop stalks belonging to a row are directed to the picking gap, and the corn stalks not belonging to a row are assigned to the adjacently arranged picking gap or, in the case of crop dividers situated at the outside, are repelled entirely.

However, under relatively difficult harvesting conditions, for example, in the case of laid corn, it is particularly difficult to ensure that the corn stalks reliably enter the picking gap even under such conditions. Since, in the case of laid corn, the corn stalks have often already buckled close to the ground and may lie along and transversely with respect to the row, a crop divider must be moved into the crop with its divider tip under the buckled corn stalks in order, as the harvesting apparatus travels onward, to lift the laid corn stalks, suitably align them with the picking gap, and support them until they have entered the picking gap. Whether a crop divider with its divider tip functions reliably even under such difficult operating conditions is dependent on the shape, the vertical guidance, and the support thereof.

The document WO 2018/134155 A1 has disclosed, also for a corn header, the possibility of adapting a crop divider to different harvesting conditions. In said document, a corn header for harvesting corn crops standing in rows is disclosed as an exemplary embodiment of a harvesting apparatus. For every row to be headed, a row unit is provided, which the crops enter as the harvesting machine travels forward into the standing crop. In the row unit, the corn stalks of a row enter a picking gap that is laterally delimited by snapping plates. The corn stalks entering the picking gap are cut and dragged downward by snapping rolls, wherein the corn cobs retained by the snapping plates are stripped from the corn stalk and are conveyed downstream out of the heading region, for further processing through the combine harvester, by conveying units. Depending on requirements, the cover that is formed as a divider tip can, with its end facing away from the working direction of the harvesting apparatus, be adjusted to different heights and locked, such that the cover can be driven, at different angles of inclination with respect to the ground, into the crop on a field. The front end of the divider tip is pointing in the working direction; however, it remains at a uniform height. The different angular positioning of the cover does not take into account the influence that the support and vertical guidance of the divider tip have on the function of a crop divider.

In order to be able to adapt a crop divider to different harvesting conditions, it is known from the document US 2023/0117424 A1 to install an extension on a crop divider that is used in a corn header, in order to thus lengthen the processing time for lifting, aligning and supporting the corn stalks. The extensions are cumbersome and expensive to produce, and it involves great effort to install the extensions on existing crop dividers, and uninstall them again, as required.

Thus, there exists a need in the art for a harvesting device having a divider tip.

### SUMMARY OF THE INVENTION

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present invention to improve on or overcome the deficiencies in the art.

The present invention relates to harvesting apparatus having at least one crop divider which has a divider tip pointing in a working direction of the harvesting apparatus, which divider tip has a basic shape which conically tapers in the working direction and which is truncated at the ground-facing side, wherein, in the ground-facing truncated region of the divider tip, there is arranged a slide plate which has a basic shape which narrows in the working direction of the harvesting apparatus, which slide plate, on its side facing toward the ground, forms a support surface by which the divider tip slides on the ground when in contact with the ground, wherein the crop divider has an exchangeable insert which, in a first installation position, protrudes with its shape beyond a surrounding part of the support surface by a first protrusion dimension in the direction of the ground and, in a second installation position, protrudes with its shape beyond a surrounding part of the support surface by a second protrusion dimension in the direction of the ground, wherein the second protrusion dimension is smaller than the first protrusion dimension and may also correspond to the value 0.

It is an object of the present invention to improve the function of the crop divider even under difficult harvesting conditions.

If the crop divider has an exchangeable insert which, in a first installation position, protrudes with its shape beyond a surrounding part of the support surface by a first protrusion dimension in the direction of the ground and, in a second installation position, protrudes with its shape beyond a surrounding part of the support surface by a second protrusion dimension in the direction of the ground, the crop divider can be easily adapted to different ground conditions. In the case of soft ground conditions, a support surface of a larger area is advantageous in order to lift the crop divider over relatively small unevennesses in the ground. A narrow support surface of a small area would sink into the ground, leading to increased wear and possible damage to the crop divider. In the case of relatively hard ground conditions, a support surface of a relatively large area is, however, disadvantageous, because any unevenness in the ground that is passed over by the support surface of a relatively large area immediately leads to a change in the height of the crop divider. The crop divider is then in constant motion, which can have the effect that it no longer reliably picks up crops that are lying on the ground. The shape of the crop divider and the design of the slide plate, therefore, always constitute merely a compromise with which it is sought to cover the various harvesting conditions as best as possible, but which, for this very reason, is of sub-optimal design for most harvesting conditions.

The exchangeable insert merely makes it possible to selectively adapt the shapes of the crop divider and of, the divider tip, and the design of the slide plate, to different ground conditions by way of different installation positions of the exchangeable insert. If the exchangeable insert, in a first installation position, protrudes with its shape beyond a surrounding part of the support surface by a first protrusion dimension in the direction of the ground, then in the case of relatively hard ground, the slide plate no longer lies with its full support surface on the ground. Rather, suppose the exchangeable insert has been installed in its first installation position. In that case, only the exchangeable insert protruding beyond a surrounding part of the support surface by a first protrusion dimension slides over the surface of the ground, and, in so doing, maintains a distance between the surrounding part of the support surface of the slide plate and the surface of the ground. Since only a partial area of the support surface of the slide plate is covered by the ground-facing surface of the exchangeable insert protruding with its shape beyond the surrounding part of the support surface, the partial area is caused to perform deflection movements by considerably fewer ground unevennesses than the full support surface of the slide plate. The divider tip thus moves much less frequently and with smaller deflection movements, and thus moves altogether considerably more smoothly over the ground. The support surface of the slide plate, which is held at a distance from the ground by the exchangeable insert situated in the first installation position, also makes less contact with the ground, and impacts less against foreign objects, thus reducing wear and the need for repair. In the case of relatively hard ground, that part of the surface of the exchangeable insert, which faces toward the ground, is nevertheless sufficient to lift the crop divider with its divider tip over unevennesses in the ground and to prevent the divider tip from sinking into the ground. This, too, reduces wear and the risk of repairs being required. However, in the case of relatively soft ground, there is the risk that that part of the area of the exchangeable insert, which faces toward the ground is no longer sufficient to provide satisfactory vertical guidance of the crop divider.

If the exchangeable insert, in a second installation position, protrudes with its shape beyond a surrounding part of the support surface by a second protrusion dimension in the direction of the ground, and this protrusion dimension is smaller than the first protrusion dimension, this self-evidently reduces the distance from the ground at which the surrounding part of the support surface is held by the exchangeable insert. In the second installation position of the exchangeable insert, that part of the support surface, which surrounds the exchangeable insert makes contact with the ground more frequently. Thus, in the second installation position of the exchangeable insert, that part of the support surface of the slide plate which surrounds the exchangeable insert is more frequently involved in the vertical guidance of the crop divider. The surrounding part of the support surface also generates an upwardly directed force component much more commonly than would be the case if the exchangeable insert were situated in the first installation position. In the case of soft ground conditions, the second installation position of the exchangeable insert and the resulting second protrusion dimension thus result in better vertical guidance, and the crop divider is thus more reliably prevented from sinking into the ground.

The improved vertical guidance of the crop divider also has the result that crops lying on the ground are more effectively picked up. Even in the case of relatively difficult ground conditions, the divider tip of the crop divider is guided uniformly at a height at which the divider tip engages under, and thereafter directly lifts, stems or stalks of the crop that are lying on the ground. The crops are thus cut and taken into the harvesting apparatus in an improved manner.

If the second protrusion dimension corresponds to the value 0, then the exchangeable insert no longer protrudes with its shape beyond the surrounding part of the support surface of the slide plate by a protrusion dimension; the shape of the exchangeable insert and of the surrounding part of the support surface then transition smoothly into one another. The shape of the exchangeable insert then forms a part of the support surface of the slide plate.

The exchangeable insert offers the advantage that it can always be carried along, in an installation position, on a corresponding crop divider of the harvesting apparatus. The harvesting apparatus is thus always ready for use. It is not necessary to keep and carry along separate parts for converting the harvesting apparatus. If an exchangeable insert is provided on a crop divider, this offers the option of improving the function of the crop divider by simply changing the installation position of said exchangeable insert. A machine operator can change the installation position of the exchangeable insert, in order to improve the function of the crop divider, only when necessary.

The exchangeable insert may be designed such that, with its shape, it forms two different protrusion dimensions depending on its installation position. The exchangeable insert may, however, also be designed such that, with its shape, it forms three or four different protrusion dimensions. The different protrusion dimensions can be set by virtue of the exchangeable insert being connected in a changed installation position to the crop divider. For example, it is possible to rotate the exchangeable insert through 180° about its transverse axis and install it into the crop divider in order to move said exchangeable insert from a first installation position into a second installation position or vice versa. If an exchangeable insert can be set into four installation positions, it is, for example, possible to rotate the exchangeable insert through 90°, 180°, or 270° about its transverse axis in order to move it into a changed installation position. Depending on the design of the exchangeable insert, rotational movements through uneven numbers of angular degrees may be necessary in order to change an installation position.

It is also possible for several exchangeable inserts that form different protrusion dimensions to be provided for one crop divider. In this case, different exchangeable inserts may be interchanged with another if it is intended to set protrusion dimensions that are possible with the other exchangeable insert. If only a single exchangeable insert that forms multiple protrusion dimensions is provided, the possible variations based on the different installation positions in which said exchangeable insert can be fastened to the crop divider are naturally limited. By means of further exchangeable inserts that offer additional installation positions and protrusion dimensions, the possible variations can be greatly expanded.

From the statements made above, it is clear that the ground tracking and sinking behavior of the crop divider, and its performance in picking up plants lying on the ground or in the vicinity of the ground, are changed depending on the protrusion dimension of the exchangeable insert and the prevailing ground condition.

In order to be able to change the installation positions of the exchangeable insert as easily as possible, it is advantageous for the exchangeable insert to be fastened to the crop divider by connecting means, which allow the installation positions to be changed quickly, and optionally also without the use of tools. For example, suitable clamp-type, hook-type, bayonet-type, clip-type, and slot-type fastenings may be provided, or an exchangeable insert is fastened in its installation position by means of screws. The fastening points for the respective installation positions are implemented mirror-symmetrically, such that connecting means provided on the crop divider can be used for fastening an exchangeable insert in different installation positions.

Where it is stated here that an exchangeable insert protrudes with its shape beyond a surrounding part of the support surface by a protrusion dimension in the direction of the ground, the shape refers in particular to the peripheral shape of the exchangeable insert in the region in which the exchangeable insert protrudes with its spatial volume beyond the surrounding part of the support surface. The exchangeable insert may be produced from a massive material, in particular metal, in this region. It is then highly resistant to damage and has acceptable wear behavior. The exchangeable insert may be produced as a single piece or may be assembled from multiple components. Where this description uses the terms “forward” or “rearward,” the term “forward” always refers to a direction oriented in a working direction, and the term “rearward” refers to a direction that is opposite to the working direction.

Where a harvesting apparatus is referred to in the context of this invention, this refers to machines that are used for cutting crops and conveying them downstream. Examples here include corn headers but also grain headers, mowers, and the like on which crop dividers are used in order to separate crops that are to be cut during in a working operation from crops that are not to be cut in said working operation, and/or to assign crops for cutting to particular regions of the harvesting apparatus.

In one refinement of the invention, the exchangeable insert is formed, at least in the protruding region, as a plate-like body. The plate-like form provides the exchangeable insert with adequate stability and strength. As a plate, the exchangeable insert may, for example, have a material thickness of 5 mm or more and consist of a metallic material.

In one refinement of the invention, the support surface of the slide plate has a passage opening through which the exchangeable insert extends in at least one installation position. Via the passage opening, the exchangeable insert can be arranged in a central position within the support surface of the slide plate. By means of the edges of the passage opening, the exchangeable insert is supported and stabilized with respect to acting forces. That part of the support surface which surrounds the exchangeable insert is formed adjacent to the passage opening. The exchangeable insert and that part of the support surface, which surrounds said exchangeable insert, form a functional unit by means of which the crop divider, supported on the ground, is guided in a functionally appropriate manner in terms of its working height. The passage opening should be shaped and dimensioned such that the exchangeable insert, when it is being installed or uninstalled, can be passed through said passage opening, but the passage opening is preferably completely or almost completely closed by the exchangeable insert when the exchangeable insert is in an installation position. By virtue of the passage opening being closed, no material can enter the region on that side of the slide plate, which faces away from the ground, where said material could impede installation work on the exchangeable insert. The most complete possible closure of the passage opening also reduces the risk of the exchangeable insert becoming jammed in one installation position by material that becomes stuck in the intermediate space between the exchangeable insert and the lateral edges of the passage opening.

In one refinement of the invention, the fastening means by which the exchangeable insert is connected to the associated crop divider are arranged on that side of the slide plate which faces away from the ground. In this region, the fastening means are protected against contamination and damage. The conversion of an exchangeable insert from one installation position into another installation position is thus simplified. Unnecessary wear to the fastening means is avoided.

In one refinement of the invention, in its front part, the support surface of the slide plate is designed to extend upward, at an angle of inclination in relation to the rear region, toward the front tip of the divider tip. By virtue of the front part of the support surface being inclined at an angle of inclination, the slide plate, in its front region, forms a type of ramp by means of which, during harvesting operation, said slide plate can ride up onto an elevation on the ground, and in so doing lift the crop divider, during the course of travel. Therefore, during harvesting operation, the tip of the slide plate does not bluntly collide with an obstruction, but said slide plate can more easily slide over said obstruction by way of a short lifting movement. The upward and downward movement of the crop divider that follows the ground contour is thus an impact-free, smooth sliding movement.

In one refinement of the invention, in at least one installation position, the lower and front tip of the exchangeable insert extends down, in the protruding region, into the plane of the rear region of the support surface of the slide plate. By virtue of the fact that the exchangeable insert extends down into the plane of the rear region of the support surface of the slide plate, the exchangeable insert can collide with, and push aside, foreign objects, such as stones and clods, that project up at least into the plane of the rear region of the support surface of the slide plate. Since obstructions are pushed aside, unnecessary upward and downward movements of the crop divider are avoided. Since the exchangeable insert extends down into said plane and no lower, the crop divider does not unnecessarily churn up the ground and bring to the surface stones and other foreign objects that cause problems there, which problems would not arise had said objects not been conveyed to the surface by the exchangeable insert. In an installation position of the exchangeable insert in which the protrusion dimension is intended to be less than the maximum possible protrusion dimension, the lower and front tip of the exchangeable insert at least does not necessarily need to extend down into the plane of the rear region of the support surface of the slide plate.

In one refinement of the invention, in at least one installation position, the lower and front tip of the exchangeable insert extends, in the protruding region, into a region situated in front of the divider tip. Since the exchangeable insert extends into a region situated in front of the divider tip, the exchangeable insert can, during harvesting operation, push foreign objects aside before they collide with the divider tip. Damage to the divider tip itself can thus be avoided, and/or impacts of foreign objects against the divider tip are less intense, whereby damage can be avoided entirely or at least lessened. In an installation position of the exchangeable insert in which the protrusion dimension is intended to be less than the maximum possible protrusion dimension, the lower and front tip of the exchangeable insert does not necessarily need to extend into a region situated in front of the divider tip.

In one refinement of the invention, the divider tip is formed as a component, which is separate from the rest of the crop divider, and which is designed as a wear shoe, and the exchangeable insert, in the installation positions, is held in the wear shoe. Since it is in constant contact with the ground, the divider tip of a crop divider is subject to particularly high wear. Furthermore, owing to possible collisions with foreign objects and obstructions, the divider tip is also at particular risk of being damaged. The same also applies to the exchangeable insert. In order to simplify the repair work in the event of wear or damage having occurred, it is advantageous if the divider tip is formed as a separate wear shoe and if the exchangeable insert is held in the wear shoe so as to also be easily exchangeable. A further advantage can be seen in the fact that one part of the crop divider is produced from a plastics material, and the wear shoe, together with the exchangeable insert, can be produced from a metallic material, such as steel or cast iron, if these are formed as separate components. The wear shoe may, however, self-evidently also be produced from a plastics material.

In one refinement of the invention, the harvesting apparatus is a corn header, and the crop divider is designed as a header cover tip which is positioned in front of, and is pivotably connected to, a heading unit. Specifically, when harvesting corn, in order to achieve optimum cutting of the corn plants, it is important that the corn stalks standing in rows are fed to an appropriate heading unit of a corn header. Therefore, during the harvesting operation, the header cover tips of corn headers are commonly held at a height at which they are in constant contact with the ground. In the case of corn headers, owing to the constant contact with the ground, it is particularly important that the header cover tips follow the ground contour with the least possible wear and without damage, and cleanly assign the bulky corn stalks to the respective heading units.

It is expressly pointed out that the refinements of the invention discussed above, each on their own or in any desired combination with one another, may be combined with the subject matter of the main claim.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

### BRIEF DESCRIPTION OF THE DRAWINGS

Several embodiments in which the present invention can be practiced are illustrated and described in detail, wherein like reference characters represent like components throughout the several views. The drawings are presented for exemplary purposes and may not be to scale unless otherwise indicated.

The invention is described below on the basis of the figures. The figures are only exemplary and do not restrict the general concept of the invention. In the figures:

FIG. 1 shows a sectional view, from the side, of a corn header as a harvesting attachment;

FIG. 2 shows a side view of a wear shoe having an exchangeable insert in a first installation position;

FIG. 3 shows a perspective view of the wear shoe shown in FIG. 2;

FIG. 4 shows a side view of a wear shoe having an exchangeable insert in a second installation position; and

FIG. 5 shows a perspective view of the wear shoe shown in FIG. 4.

An artisan of ordinary skill in the art need not view, within isolated figure(s), the near infinite number of distinct permutations of features described in the following detailed description to facilitate an understanding of the present invention.

### DETAILED DESCRIPTION OF THE INVENTION

The present disclosure is not to be limited to that described herein. Mechanical, electrical, chemical, procedural, and/or other changes can be made without departing from the spirit and scope of the present invention. No features shown or described are essential to permit basic operation of the present invention unless otherwise indicated.

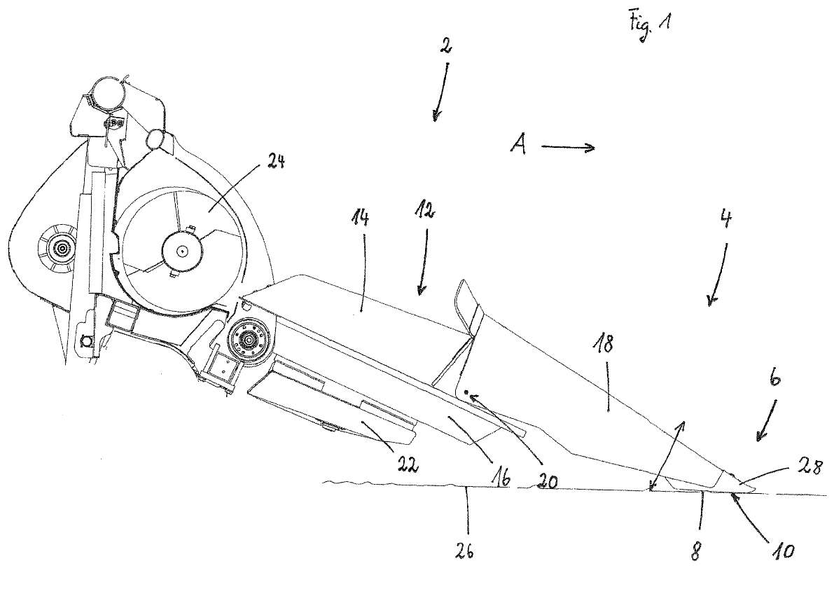

Referring now to FIG. 1, which shows a sectional view, from the side, of a corn header as an exemplary embodiment of a harvesting apparatus 2. In its front region, the harvesting apparatus 2 has a crop divider 4 having a divider tip 6. The divider tip 6 points in a working direction A of the harvesting apparatus 2 and has a basic shape, which conically tapers in the working direction A and which is truncated at the ground-facing side. On the underside of the divider tip 6, in the ground-facing truncated region thereof, there is situated a slide plate 8, which likewise has a basic shape, which narrows in the working direction A of the harvesting apparatus 2. The slide plate 8 has, on its side facing toward the ground 26, a support surface 10 by which the slide plate 8 can slide over the ground 26.

The corn header has a heading apparatus 12 in which the corn cobs can be severed from the stalks. The heading apparatus 12 is partially covered by a header cover 14. The heading unit 16 is situated underneath the header cover 14. Situated in front of the heading unit 16 is the header cover tip 18, which is connected, so as to be articulated about the center of rotation 20, to the header cover 14, and thus also to the heading unit 16. In the exemplary embodiment, the header cover tip 18 forms the crop divider 4. Normally, in a corn header, several heading apparatuses 12, for example, 6, 8, or 12 heading apparatuses 12, are arranged adjacent to one another. The corn stalks entering the heading apparatuses 12 are directed by means of the crop dividers 4 to a corresponding heading apparatus 12.

A chopping apparatus 22 is situated underneath the heading apparatus 12. In the exemplary embodiment shown, the chopping apparatus 22 consists of two chopping blades, which are fastened to a blade shaft, and which rotate at a high rotational speed during the operation of the harvesting machine. The chopping blades cut the corn stalks close to the ground, but also chop up those crop stalks which have been dragged downward by the snapping rolls. For this purpose, the chopping apparatus 22 is arranged approximately below the heading apparatus 12.

In the region of the heading apparatus 12, as the harvesting machine travels forward, the crop stalks enter a picking gap which is delimited by lateral snapping plates, and are taken hold of there by snapping rolls situated below snapping plates. Here, the corn cobs are stripped from the stalks by those edges of the snap-ping plates which adjoin the picking gap. The corn cobs that have been detached from the stalks are then fed by a conveying device 24 to a harvesting machine (not illustrated in any more detail in the drawing), such as a combine harvester, on which the harvesting attachment 2 is mounted. In FIG. 1, the reference designation 24 denotes a conveying screw; however, in the region of the heading apparatus 12, there are also situated chain-type conveyors (not shown in the illustration) having drivers which convey the picked corn cobs to the conveying screw.

During the harvesting operation, the harvesting apparatus 2 is held by the harvesting machine at a height at which the header cover tip 18 lies with the support surface 10 of the slide plate 8 on the ground 26. In the case of unevennesses in the ground 26, the header cover tip 18 can, with its end pointing in the working direction A, move upward and downward about the axis of rotation 20, as indicated by the double arrow. The header cover tip 18 thus floats on the surface of the ground 26 and thus continuously adapts to a changing contour of the ground surface. The divider tip 6 is thus always held at a height at which it can lift laid corn stalks, and direct them in the same way as standing corn stalks to a heading unit 16.

In the exemplary embodiment shown, the header cover tip 18 has a wear shoe 28, which in the exemplary embodiment forms the divider tip 6 of the crop divider 4. The wear shoe 28, which in the exemplary embodiment forms the divider tip 6, is formed as a component that is separate from the rest of the crop divider 4.

From the side view in FIG. 1, it can be understood that, during the harvesting operation, the divider tip 6 can plunge with the wear shoe 28 into the ground if the lift generated by the support surface 10 is not sufficient to hold the divider tip 6 on the surface of the ground. The support surface 10 must, therefore, be dimensioned to be large enough to generate adequate lift. However, a support surface 10 of excessively large dimensions also leads to unnecessary wear and to a risk of damage, in particular on relatively solid ground where the risk of the divider tip 6 penetrating into the ground is not so high.

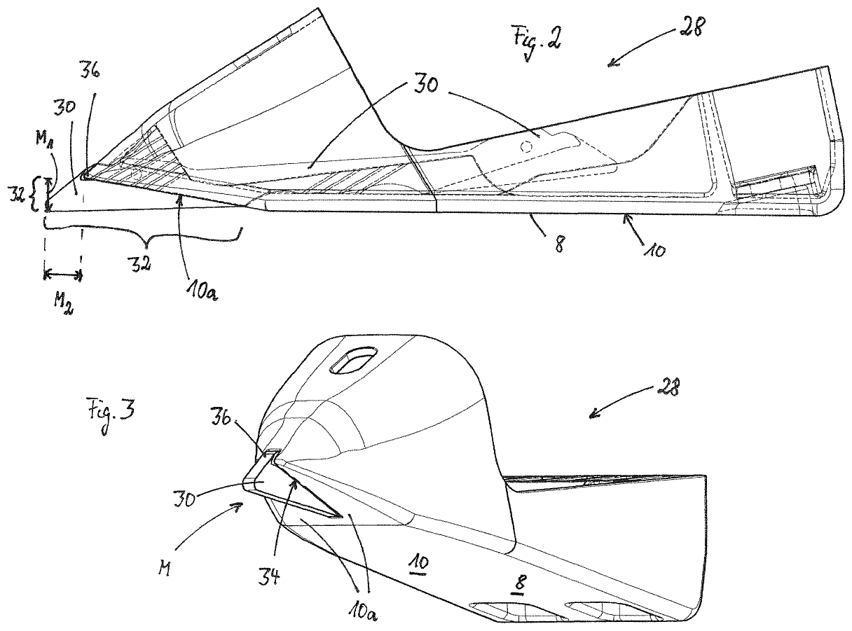

FIG. 2 shows a wear shoe 28 which is fastenable to the crop divider 4 and which has an exchangeable insert 30 in the region of its front tip 36. In the first installation position shown in FIG. 2, the exchangeable insert 30 protrudes with a part of its shape, in the protruding region 32 indicated by curly brackets, beyond the surrounding part 10a of the support surface 10 by a first protrusion dimension M in the direction of the ground 26. Since the surrounding or front part 10a of the support surface 10 of the slide plate 8 in the exemplary embodiment is designed to extend upward, at an angle of inclination in relation to the rear region, toward the front tip 36, the exchangeable insert 30 protrudes with an approximately triangular shape beyond the surrounding part 10a of the support surface 10.

That part of the exchangeable insert 30, which does not protrude outward beyond the surrounding part 10a of the support surface 10, is situated in the interior of the wear shoe 28 and is illustrated using dashed lines. In the exemplary embodiment shown, the shape of the exchangeable insert 30 in the protruding region 32 results in both a protrusion with the maximum protrusion dimension M₁ in a vertical direction in relation to the foremost tip of the wear shoe 28 and a protrusion with the maximum protrusion dimension M₂ in a horizontal direction in relation to the foremost tip of the wear shoe 28. Owing to the upwardly sloping form of the support surface 10 in its surrounding or front part 10a and the approximately horizontally extending the lower base line of the protruding part of the exchangeable insert 30, the protrusion dimension M₁ in the vertical direction increases toward the front. In the first installation position shown, the lower and front tip of the exchangeable insert 30 extends, in the protruding region, in a horizontal direction into a region situated in front of the tip of the wear shoe 28 and thus in front of the divider tip 6. The shape of the exchangeable insert 30 may also be selected such that the corresponding protrusion dimensions differ from the exemplary embodiment shown. It is also apparent that, in the installation position shown, the lower and front tip of the exchangeable insert 30 extends down, in the protruding region 32, in the vertical direction into the plane of the rear region of the support surface 10 of the slide plate 8.

FIG. 3 shows a perspective view of the wear shoe 28 shown in FIG. 2. In this perspective view, it can be clearly seen that the exchangeable insert 30 is formed, at least in the protruding region 32, as a plate-like body. It can also be seen that the support surface 10 of the slide plate 8 has a passage opening 34 through which the exchangeable insert 30 extends in the illustrated first installation position.

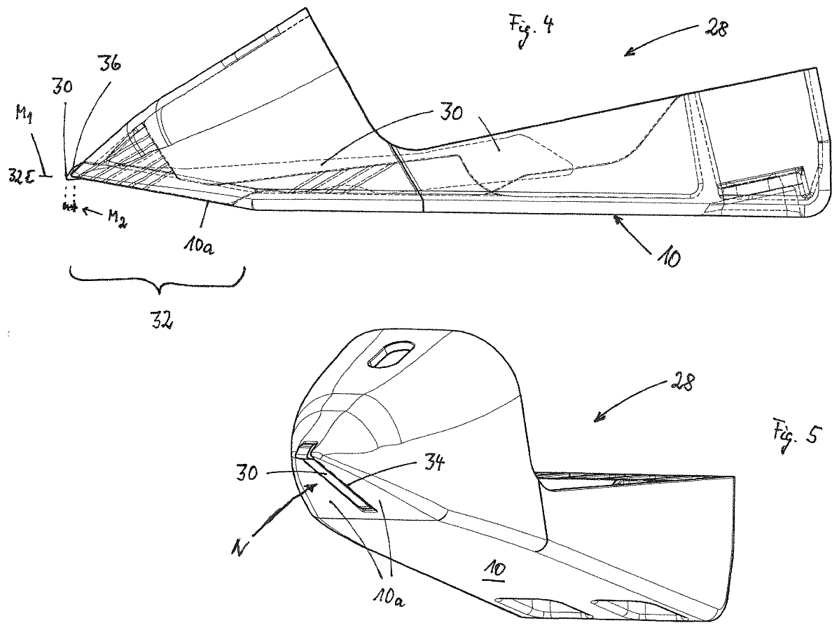

FIGS. 4 and 5 show the wear shoe 28 when the exchangeable insert 30 is situated in a second installation position. In the exemplary embodiment shown, the shape of the exchangeable insert 30 is selected such that it protrudes with its shape with a second protrusion dimension, the value of which is equal to or approximately 0, in the direction of the ground 26. The protrusion dimension M₁ in the vertical direction is exactly 0, and the protrusion dimension M₂ in the horizontal direction is approximately 0. From the contours (illustrated using dashed lines) of the exchangeable insert 30 that is situated in the interior of the wear shoe 28, it can be seen that, in relation to the first installation position shown in FIGS. 2 and 3, the exchangeable insert 30 has been rotated through 1800 about the vertical axis in order to be able to assume the second installation position. From the illustrations in FIGS. 2 and 3 in relation to FIGS. 4 and 5, it can be seen that the second protrusion dimension N by which the shape of the exchangeable insert 30 protrudes beyond the surrounding part 10a of the support surface 10 is smaller in the second installation position than in the first installation position.

In the illustrated second installation position, the surrounding part 10a of the support surface 10 is planar as seen in side view, such that the wear shoe 28, when in contact with the ground, can slide with the entire area of the support surface 10 on the ground 26. If the exchangeable insert 30 is situated in the first installation shown in FIGS. 2 and 3, and at least in the case of relatively hard ground 26, the approximately horizontally extending the lower base line of the protruding part of the exchangeable insert 30 would slide on the ground, but the surrounding part 10a of the support surface 10 would not.

In the perspective view in FIG. 5, it can also be seen that, in the second installation position, the shape of the exchangeable insert 30 fills the passage opening 34, such that no foreign objects or material from the ground can enter the interior of the wear shoe 28 through the passage opening 34.

The exemplary embodiment described above serves merely for explaining the invention. The invention is not restricted to the exemplary embodiment shown. A person skilled in the art would have no difficulty in modifying the exemplary embodiment in a way that appears suitable to them in order to adapt said exemplary embodiment to a specific usage situation. The invention is not restricted to the exemplary embodiment discussed above. A person skilled in the art would have no difficulty in modifying the exemplary embodiment in a way that appears suitable to them in order to adapt the exemplary embodiment to a specific usage situation.

From the foregoing, it can be seen that the present invention accomplishes at least all of the stated objectives.

### LIST OF REFERENCE CHARACTERS

The following table of reference characters and descriptors are not exhaustive, nor limiting, and include reasonable equivalents. If possible, elements identified by a reference character below and/or those elements which are near ubiquitous within the art can replace or supplement any element identified by another reference character.

TABLE 1
List of Reference Characters

| | |
|---|---|
| 2 | Harvesting apparatus |
| 4 | Crop divider |
| 6 | Divider tip |
| 8 | Slide plate |
| 10 | Support surface |
| 10a | Surrounding part |
| 12 | Heading apparatus |
| 14 | Header cover |
| 16 | Heading unit |
| 18 | Header cover tip |
| 20 | Center of rotation |
| 22 | Chopping apparatus |
| 24 | Conveying apparatus |
| 26 | Ground |
| 28 | Wear shoe |
| 30 | Exchangeable insert |
| 32 | Protruding region |
| 34 | Passage opening |
| 36 | Front tip |
| A | Working direction |
| M | A first protrusion dimension in the direction of the ground 26. |
| N | A second protrusion dimension in the direction of ground 26. |
| M₁ | Maximum protrusion dimension in a vertical direction in relation |
| | to the foremost tip of the wear shoe 28 |
| M₂ | Maximum protrusion dimension in a horizontal direction in |
| | relation to the foremost tip of the wear shoe 28 |

### Glossary

Unless defined otherwise, all technical and scientific terms used above have the same meaning as commonly understood by one of ordinary skill in the art to which embodiments of the present invention pertain.

The terms “a,” “an,” and “the” include both singular and plural referents.

The term “or” is synonymous with “and/or” and means any one member or combination of members of a particular list.

The terms “invention” or “present invention” are not intended to refer to any single embodiment of the particular invention but encompass all possible embodiments as described in the specification and the claims.

The term “about” as used herein refers to slight variations in numerical quantities with respect to any quantifiable variable. Inadvertent error can occur, for example, through the use of typical measuring techniques or equipment or from differences in the manufacture, source, or purity of components.

The term “substantially” refers to a great or significant extent. “Substantially” can thus refer to a plurality, majority, and/or a supermajority of the quantifiable variable, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the present invention is defined by the appended claims, along with the full scope of equivalents to which such claims are entitled. The scope of the invention is further qualified as including any possible modification to any of the aspects and/or embodiments disclosed herein which would result in other embodiments, combinations, subcombinations, or the like that would be obvious to those skilled in the art.

What is claimed is:

1. A harvesting apparatus (2) comprising of:
at least one crop divider (4) which has a divider tip (6) pointing in a working direction (A) of the harvesting apparatus (2), which divider tip (6) has a basic shape which conically tapers in the working direction (A) and which is truncated at the ground-facing side, wherein, in the ground-facing truncated region of the divider tip (6), there is arranged a slide plate (8) which has a basic shape which narrows in the working direction (A) of the harvesting apparatus (2), which slide plate, on its side facing toward the ground (26), forms a support surface (10) by which the divider tip (6) slides on the ground (26) when in contact with the ground; and
an exchangeable insert (30) of the at least one crop divider (4) includes a first installation position, protrudes with its shape beyond a surrounding part (10a) of the support surface (10) by a first protrusion dimension (M) in the direction of the ground (26) and, in a second installation position, protrudes with its shape beyond a surrounding part (10a) of the support surface (10) by a second protrusion dimension (N) in the direction of the ground (26), wherein the second protrusion dimension (N) is smaller than the first protrusion dimension (M).

2. The harvesting apparatus (2) according to claim 1, wherein the second protrusion dimension (N) may also correspond to the value 0.

3. The harvesting apparatus (2) according to claim 1, wherein the exchangeable insert (30) is formed, at least in a protruding region (32), as a plate-like body.

4. The harvesting apparatus (2) according to claim 1, wherein the support surface (10) of the slide plate (8) has a passage opening (34) through which the exchangeable insert (30) extends in at least one installation position.

5. The harvesting apparatus (2) according to claim 1, wherein the fastening means by which the exchangeable insert (30) is connected to the associated crop divider (4) are arranged on that side of the slide plate (8), which faces away from the ground (26).

6. The harvesting apparatus (2) according to claim 1, further comprising a surrounding part (10a) for the support surface (10) of the slide plate (8) that is designed to extend upward, at an angle of inclination in relation to the rear region, toward a front tip (36) of the divider tip (6).

7. The harvesting apparatus (2) according to claim 3, wherein a lower and front tip of the exchangeable insert (30) extends down, in the protruding region (32), into the plane of the rear region of the support surface (10) of the slide plate (8) in at least one installation position.

8. The harvesting apparatus (2) according to claim 7, wherein the lower and front tip of the exchangeable insert (30) extends, in the protruding region (32), into a region situated in front of the divider tip (6).

9. The harvesting apparatus (2) according to claim 1, wherein the divider tip (6) is formed as a component that is separate from the rest of the crop divider (4) and in a form of a wear shoe (28), and the exchangeable insert (30), in the installation positions, is held in the wear shoe (28).

10. The harvesting apparatus (2) according to claim 1, wherein the harvesting apparatus (2) is a corn header, and the crop divider (4) is in a form of a header cover tip (18), which is positioned in front of, and is pivotably connected to, a heading unit (16).
